(19) United States
(12) Patent Application Publication
(10) Pub. No.: US 2026/0307831 A1
(43) Pub. Date: Oct. 8, 2026

(54) PORTABLE COOLING PLATFORM FOR UNMANNED AUTONOMOUS AERIAL VEHICLE LANDING AND TAKEOFF, AND ALIGNMENT METHOD THEREOF

(71) Applicant: Electronics and Telecommunications Research Institute, Daejeon (KR)

(72) Inventors: Sanghyouk CHOI, Daejeon (KR); Suseong Kim, Daejeon (KR)

(21) Appl. No.: 19/045,741

(22) Filed: Feb. 5, 2025

(30) Foreign Application Priority Data
Oct. 21, 2024 (KR) 10-2024-0143975

(51) Int. Cl. B64U 70/92; B64U 10/14; B64U 70/99; F04D 27/00

(52) U.S. Cl. CPC B64U 70/92; B64U 10/14; B64U 70/99; F04D 27/008

(57) ABSTRACT

Proposed is a portable cooling platform for taking off and landing of an unmanned autonomous aerial vehicle and an alignment method thereof, which includes a take-off and landing pad composed of a landing surface where a drone lands, a supporter for supporting the take-off and landing pad on the ground; and a cooling fan provided on the take-off and landing pad for blowing wind in a landing direction of the drone.

### CROSS REFERENCE TO RELATED APPLICATION

The present application claims priority to Korean Patent Application No. 10-2024-0143975, filed on Oct. 21, 2024, the entire contents of which are incorporated herein for all purposes by this reference.

### BACKGROUND

### Technical Field

The present disclosure relates to a portable cooling platform for taking off and landing of an unmanned autonomous aerial vehicle, which cools a drone's LiDAR sensor sensitive to overheating from a takeoff preparation stage and enables automatic orientation alignment.

### Description of the Related Art

Unmanned Aerial Vehicle (UAV) technology has been rapidly developing in recent years and is being utilized in various industrial fields. These unmanned autonomous flight drones recognize the surrounding environment and fly autonomously by mainly utilizing optical-based sensors such as EO cameras, IR cameras, LiDAR, GPS, and the like.

As a sensor for overcoming GPS shadow areas, LiDAR sensor is a core technology that measures the distance to surrounding objects by using laser pulses and enables 3D mapping. GPS is used to identify the exact location of drones, and cameras collect visual information to be utilized for obstacle detection and route planning.

The combination of these sensors allows drones to fly safely and perform missions even in complex environments.

However, the optical-based sensors described above may suffer from performance degradation under certain environmental conditions, which may affect the safety and reliability of drones.

Problems for the performance degradation of unmanned autonomous flight drones under the certain environmental conditions described above are as follows.

First, flying debris such as dust, sand, and small particles generated when a drone takes off can adhere to the lenses or sensor surfaces of optical-based sensors such as LiDAR and cameras, which can reduce the accuracy of the sensors or cause malfunction, thereby hindering the drone's safe flight and accurate mission performance. Furthermore, flying debris such as dust, sand, and small particles generated when a drone takes off can cause problems of physically damaging expensive sensors.

Naturally, a landing station for landing drones has been introduced in the conventional work in order to solve the problem of performance degradation and damage of optical-based sensors caused by flying debris such as dust, sand, and small particles generated when a drone takes off, but the lack of the portability makes it not suitable for the purpose of taking off and landing of drones while moving from place to place to perform drone's various missions.

Second, LiDAR sensor among optical-based sensors generates significant heat during operations, which can negatively affect the performance and lifetime of the LiDAR sensor.

To solve these problems, a drone is equipped with a heat sink, which increases the weight of the drone and affects flight performance, so most drones are flying with the heat sinks removed. In this case, the wind naturally cools the LiDAR sensor during flight so there is no problem caused by overheating even when the heat sink is removed.

However, drones do not fly directly to perform missions, but require time to prepare for takeoff, such as inputting data in a state where the LiDAR sensor is activated, and then the LiDAR sensor may be overheated while the drone is waiting for the takeoff preparation, so a solution is required to solve the overheating problem of the LiDAR sensor while the drone is waiting to take off.

### RELATED ART DOCUMENTS

### Patent Document

(Patent Document 1) Korean Patent No. 10-2604812

### SUMMARY

An objective of the present disclosure is to provide a portable cooling platform for taking off and landing of an unmanned autonomous aerial vehicle, which is easily portable while protecting optical-based sensors mounted on a drone from debris flying from the ground when the drone takes off and lands.

Another objective of the present disclosure is to provide a portable cooling platform for taking off and landing of an unmanned autonomous aerial vehicle, which is capable of preventing overheating of optical-based sensors mounted on a drone by blowing wind on a lower part of the drone in the preparation stage for the drone's take-off.

Another objective of the present disclosure is to provide an alignment method of a portable cooling platform for taking off and landing an unmanned autonomous aerial vehicle, which enables horizontality alignment with respect to the ground and orientation alignment with respect to a location when changing a location because of moving to locations for performing missions.

In order to achieve the objectives of the present disclosure, the present disclosure provides a portable cooling platform for taking off and landing of an unmanned autonomous aerial vehicle, which includes a take-off and landing pad comprising of a landing surface where a drone lands, a supporter for supporting the take-off and landing pad on the ground, and a cooling fan provided on the take-off and landing pad for blowing wind in a landing direction of the drone.

At this time, the take-off and landing pad may include a plurality of fixing parts, which prevent the drone's movement by fixing the drone's legs when the drone lands on the landing surface.

At this time, the fixing part may form a groove into which the drone's legs are inserted and coupled.

In addition, the fixing part may be formed in a circumference of the cooling fan, so that a lower center of the drone can correspond to the cooling fan when the drone's legs are fixed into the fixing parts.

In addition, the take-off and landing pad may form a cooling fan groove stepped from the landing surface so that the cooling fan can be installed, and a blowing net may be formed in the cooling fan groove for protecting the cooling fan.

In addition, further included may be a sensor part for measuring a horizontality and orientation of the take-off and landing pad, an actuator formed between the supporter and the take-off and landing pad for driving a movement of the take-off and landing pad, and a controller for controlling the actuator on the basis of a horizontality value and orientation value of the take-off and landing pad measured through the sensor part.

At this time, the actuator may include a first motor for adjusting an azimuth of the take-off and landing pad while generating power to horizontally rotate (yaw) with respect to the ground, a second motor for adjusting a slope of a first area while generating power to vertically rotate (pitch) with respect to a rotation axis of the first motor, and a third motor for adjusting a slope toward a second area perpendicular to the first area while generating power to vertically rotate (roll) with respect to a rotation axis of the second motor.

In addition, an operation of the cooling fan may be controlled to be turned off when the sensor part measures the orientation.

In addition, further included may be a power supplier for supplying power to the portable cooling platform for taking off and landing of the unmanned autonomous aerial vehicle.

In this case, the power supplier may be configured to incorporate a battery thereof or to be supplied with power from an external power source.

In addition, further included may be an interface where location information of the take-off and landing pad can be input.

In addition, the supporter may be formed as a foldable tripod.

As another example of the present disclosure for achieving the objectives, provided is a portable cooling platform for taking off and landing of an unmanned autonomous aerial vehicle, which includes a take-off and landing pad composed of a landing surface where a drone lands, a cooling fan provided on the take-off and landing pad for blowing wind in a landing direction of the drone, a power supplier provided on a lower side of the take-off and landing pad for supplying power, an actuator formed between the power supplier and the take-off and landing pad for driving a movement of the take-off and landing pad, a supporter formed on the power supplier and supported on the ground, wherein the supporter can be unfolded to be supported on the ground and be folded to be transportable.

At this time, further included may be a sensor part formed on one surface of the take-off and landing pad for measuring a horizontality and orientation of the take-off and landing pad, and a controller formed on one side of the sensor part for controlling the actuator on the basis of a horizontality value and orientation value of the take-off and landing pad measured through the sensor part.

As another example of the present disclosure for achieving the objectives, provided is an alignment method of a portable cooling platform for taking off and landing of an unmanned autonomous aerial vehicle, which includes receiving, horizontality data and orientation data of a take-off and landing pad measured from a sensor part by a controller, determining whether true north/magnetic north is aligned through the data received by the controller, calculating, by the controller, an actuator control value for the true north alignment of the take-off and landing pad when location information of the take-off and landing pad is known calculates or calculating, by the controller, an actuator control value for the magnetic north alignment of the take-off and landing pad when the location information of the take-off and landing pad is not known, and aligning, by the controller, the horizontality and orientation of the take-off and landing pad by driving the actuator.

At this time, the controller may turn off an operation of a cooling fan when the sensor part measures the orientation of the take-off and landing pad.

In addition, after the aligning, determining an error range, where whether noise of the data measured by the sensor part is out of an allowable range is determined, and maintaining, the current state of the actuator by the controller when the noise of the sensor part is within the allowable range in the determining error range.

At this time, the maintaining may turn on the operation of the cooling fan by the controller.

In addition, identifying, whether a user inputs the orientation data of the take-off and landing pad as a new value into the controller is further performed after the maintaining, wherein in the identifying, the maintaining, by the controller, is maintained until power is turned off when it is identified that the new value is not input, and the receiving, is returned by the controller, and performed again when it is identified that the new value is input.

In addition, the determining, by the controller, may perform at least one of whether the sensor part is composed of a GPS, whether the orientation data input by a user is present, and whether a file where the orientation data is recorded is present.

The effects of the present disclosure obtained through the solutions described above are as follows.

First, the present disclosure has the effect of preventing damage to various components mounted on a drone by blocking foreign substances scattered from the ground when the drone takes off and lands. In particular, the present disclosure can protect optical-based sensors and lens formed on a lower part of the drone, so that the optical-based sensor can perform the original function thereof without any interruption, thereby having the effect of preventing physical damage.

Second, the platform of the present disclosure is portable, so it has the effect of performing various missions by utilizing a drone in various fields.

In addition, the present disclosure can control horizontality and orientation with respect to the ground even in situations where the slope or orientation of the terrain can vary according to the change in the installation location, so there is the effect of not only supporting the accurate mission performance of the drone but also ensuring the safe return of the drone after the mission is completed.

Third, the present disclosure has the effect of improving the overall stability of the drone by preventing heat accumulation in drone components through a cooling fan and particularly solving performance degradation due to overheating of the LiDAR sensor. In addition, the present disclosure prevents sensor overheating by providing cooling to the LiDAR sensor before takeoff, so there is the effect of securing sufficient takeoff preparation time for stable mission performance.

### BRIEF DESCRIPTION OF THE DRAWINGS

FIG. 1 is a configuration view showing a portable cooling platform for taking off and landing of an unmanned autonomous aerial vehicle according to a preferred exemplary embodiment of the present disclosure.

FIG. 2 is a view showing a portable cooling platform for taking off and landing of an unmanned autonomous aerial vehicle according to a preferred exemplary embodiment of the present disclosure.

FIG. 3 is a view showing a state in which an unmanned autonomous aerial vehicle is landed on a portable cooling platform for taking off and landing of an unmanned autonomous aerial vehicle according to a preferred exemplary embodiment of the present disclosure.

FIG. 4 is a flowchart showing an alignment method of a portable cooling platform for taking off and landing of an unmanned autonomous aerial vehicle according to another exemplary embodiment of the present disclosure.

### DETAILED DESCRIPTION OF THE DISCLOSURE

Hereinafter, a portable cooling platform for taking off and landing of an unmanned autonomous aerial vehicle will be described in more detail with reference to the drawings.

In describing an exemplary embodiment disclosed in the present specification, the detailed description thereof will be omitted when it is determined that a detailed description of a related known technology may obscure the gist of the exemplary embodiment disclosed in the present specification.

The accompanying drawings may only be intended to facilitate understanding of an exemplary embodiment disclosed in the present specification, and it should be understood that the technical ideas disclosed in the present specification are not limited by the accompanying drawings and include all modifications, equivalents, or substitutions that are within the scope of the ideas and technology of the present disclosure.

In the following description, a singular expression may include a plural expression unless the context clearly indicates otherwise.

In this application, it should be understood that the terms such as “include”, “have” or the like are intended to specify the existence of features, numbers, steps, operations, components, parts, or combinations thereof described in the present specification, and do not exclude in advance the possibility of the presence or addition of one or more other features, numbers, steps, operations, components, parts, or combinations thereof.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C).

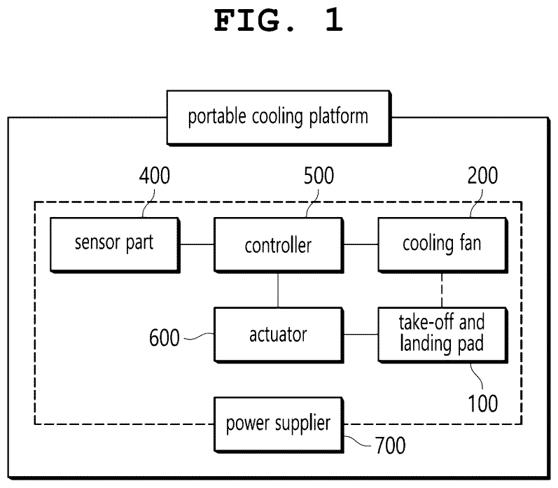

Hereinafter, a portable cooling platform for taking off and landing of an unmanned autonomous aerial vehicle (hereinafter referred to as “a portable cooling platform”) according to a preferred exemplary embodiment of the present disclosure will be described with reference to FIGS. 1 to 3.

The portable cooling platform may stabilize the take-off and landing of unmanned autonomous aerial vehicles (drones) that take off and land vertically, and may protect optical-based sensors mounted on the drones. In particular, the cooling platform may cool heat-sensitive LiDAR sensor even before the drone takes off, thereby securing sufficient take-off preparation time for drones.

As shown in FIGS. 1 to 3, the portable cooling platform may include a take-off and landing pad 100, a cooling fan 200, a supporter 300, a sensor part 400, a controller 500, an actuator 600, and a power supplier 700.

The take-off and landing pad 100 may form a flat landing surface 100a where a drone can take off and land vertically, and may be formed in a rectangular shape when viewed from a plane. Naturally, the shape of the take-off and landing pad 100 may not be limited to a rectangular shape.

At this time, the take-off and landing pad 100 may be made of a highly durable material and may be made of a non-conductive material to minimize magnetic field distortion.

Meanwhile, the take-off and landing pad 100 may form a cooling fan groove 110 at the center thereof.

The cooling fan groove 110 may be a space for installing the cooling fan 200 to be described later and may be in the form of a groove stepped from the landing surface 100a. At this time, the cooling fan groove 110 may be formed in a circular shape to facilitate smooth rotation of the cooling fan, but the shape may not be limited thereto.

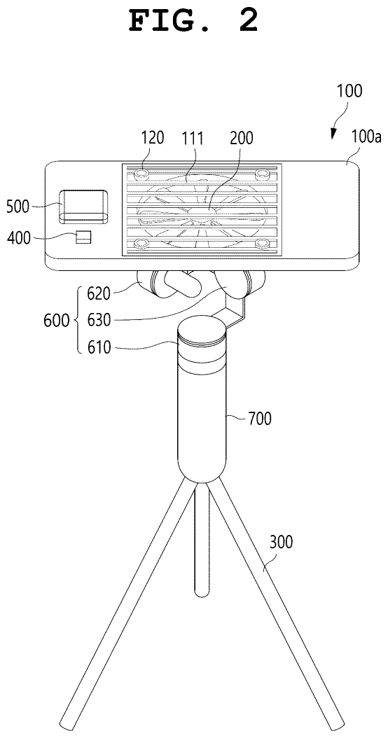

At this time, the cooling fan groove 110 may further include a blowing net 111 as shown in FIG. 2. The blowing net 111 may prevent foreign substances from flowing into the cooling fan groove 110 and may allow the cooling fan 200 to blow air smoothly.

Meanwhile, the take-off and landing pad 100 may form a fixing part 120.

The fixing part 120 may serve to prevent the movement of the drone landed on the take-off and landing pad 100, and may be formed in a plurality in the circumference of the cooling fan groove 110 as shown in FIG. 2.

By limiting the movement of the drone landed on the landing surface 100a, the fixing part 120 may be capable of enabling the automatic orientation alignment of the drone without any further operation when the drone lands on the landing surface 100a in a state where the orientation alignment of the take-off and landing pad 100 is completed.

In addition, the fixing part 120 may automatically correspond the cooling fan 200 to the lower center of the drone through the location alignment of the drone on the landing surface 100a.

To this end, the fixing parts 120 may be disposed in the circumference of the cooling fan 200, and the location of the fixing part 120 may be set so that the lower part of the drone accurately corresponds to the lower side of the cooling fan 200 when the drone's legs are coupled to the fixing parts 120.

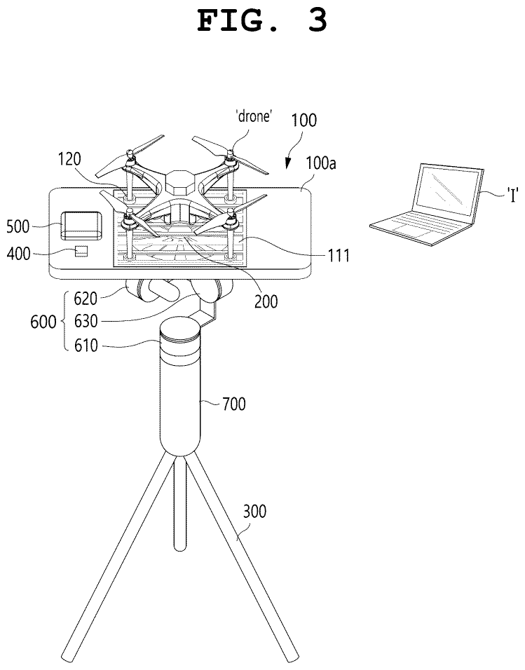

As shown in FIG. 3, the fixing part 120 may form a groove into which the drone's legs are inserted and coupled, but it may not be necessary to form a groove. It may be sufficient that the fixing part 120 is configured to restrict the movement of the drone when the drone is landed on the landing surface 100a.

Next, the cooling fan 200 may serve to cool the components of the drone landed on the take-off and landing pad 100 while being prepared for take-off and may be installed in the cooling fan groove 110 of the take-off and landing pad 100.

The cooling fan 200 may be formed to blow air upward from the cooling fan groove 110, thereby blowing air toward the lower part of the drone landed on the landing surface 100a of the takeoff and landing pad 100. In particular, the cooling fan 200 may cool the LiDAR sensor generating a lot of heat among the main components of the drone, thereby preventing overheating of the LiDAR sensor.

At this time, the cooling fan 200 may operate to cool the LiDAR sensor when the drone is preparing to take off in the landing surface 100a, thereby cooling the LiDAR sensor even in a state when the drone is preparing for takeoff.

Next, the supporter 300 may serve to support the take-off and landing pad 100 on the ground and may be formed toward the lower side of the take-off and landing pad 100.

The supporter 300 may be designed to fold and unfold for convenience of portability, and may be formed as a tripod as shown in FIG. 2.

That is, the supporter 300 may support the take-off and landing pad 100 on the ground while being unfolded in three directions, and may be in a foldable form for easy transport. The supporter 300 formed as such a tripod can be formed in a foldable form.

In this case, although not shown, the supporter 300 may be configured to be adjustable in length.

Next, the sensor part 400 may serve to provide data to the controller 500 by measuring the slope and orientation of the take-off and landing pad 100, and may be formed on one surface of the take-off and landing pad 100.

The sensor part 400 may serve to measure the horizontality of the take-off and landing pad 100 with respect to the ground and the orientation for the true north alignment of the take-off and landing pad 100.

The sensor unit 400 may include an accelerometer sensor and an AHRS module, for the horizontality measurement of the take-off and landing pad 100, an IMU sensor and an electronic compass, for the orientation measurement.

In this case, the accelerometer sensor, the AHRS module, the IMU sensor, and the electronic compass may be known technologies, so detailed descriptions will be omitted.

Meanwhile, the sensor part 400 may further include a GPS.

Next, the controller 500 may calculate horizontal and directional control values of the take-off and landing pad 100 by using the magnetic field and acceleration measurement values provided by the sensor part 400, and may serve to control the actuator 600 by using the values. In addition, the controller 500 may manage the operations of the cooling fan 200.

The controller 500 may control the horizontality of the take-off and landing pad 100 by aligning the gravitational acceleration to coincide with the vertical axis with respect to the ground by using the three-axis acceleration value of the take-off and landing pad 100.

In addition, when the controller 500 performs the true north direction alignment of the landing body by utilizing the magnetic field data provided by the sensor part 400, the magnetic field data of the sensor part 400 may be data such as the World Magnetic Model (WMM) provided by the National Geospatial-Intelligence Agency (NGA) in the United States and the Defense Geographic Centre (DGC) in the United Kingdom.

At this time, latitude, longitude, and altitude values where the take-off and landing pad 100 is installed may be required in order to utilize data such as WMM, so the sensor part 400 may include a GPS receiver or the controller 500 may allow the user to directly input latitude, longitude, and altitude values.

To this end, the controller 500 may include an interface (I) capable of wirelessly communicating with a laptop, a smartphone, a tablet or the like as shown in FIG. 3.

In this case, the latitude, longitude, and altitude may be recorded as data such as a text file that can be loaded by a ROM memory or the controller 500, such that by using the data the GPS shadow area or the sensor part 400 not having the GPS can align the true north of the take-off and landing pad 100. At this time, when it is difficult to identify the latitude, longitude, and altitude of the take-off and landing pad 100 through the sensor part 400, the orientation of the take-off and landing pad 100 may be aligned with the magnetic north.

In addition, the controller 500 may control the operations of the cooling fan 200 so that distortion does not occur in the magnetic field when the sensor part 400 measures the magnetic field. That is, the controller 500 may turn off the operations of the cooling fan 200 so that distortion of the magnetic field caused by the cooling fan 200 does not occur while the sensor part 400 measures magnetic field and gravitational acceleration, and then may turn on the cooling fan 200 after horizontality and orientation control with respect to the take-off and landing pad 100 is completed.

Next, the actuator 600 may serve to physically adjust the horizontality and orientation of the take-off and landing pad 100, and may be formed between the supporter 300 and the take-off and landing pad 100.

At this time, the actuator 600 may be configured to rotate the take-off and landing pad 100 in all directions, and may preferably be formed in a structure such as a three-axis gimbal.

The actuator 600 may perform three-axis rotation by using rotational power of a motor, and may be composed of a first, second, and third motor 610, 620, 630, as shown in FIG. 2.

The first motor 610 may serve to adjust the azimuth of the take-off and landing pad 100 while generating power (yaw) that rotates horizontally with respect to the ground.

The second motor 620 may serve to adjust the slope of the take-off and landing pad 100 to a first area while generating power (pitch) that rotates vertically with respect to the first motor 610. At this time, the first area may refer to the left and right sides of the take-off and landing pad 100.

The third motor 630 may serve to adjust the slope to a second area perpendicular to the first area while generating power (roll) that rotates vertically with respect to the second motor 620. At this time, the second area may refer to the front and rear of the take-off and landing pad 100.

Next, the power supplier 700 may serve to supply power to the cooling fan 200, the sensor part 400, the controller 500, and the actuator 600, and may be formed between the supporter 300 and the actuator 600.

The power supplier 700 may incorporate a battery itself for power supply, or may also be supplied with power through an external power source.

The power supplier 700 may be formed in a cylindrical shape, but the shape is not limited thereto.

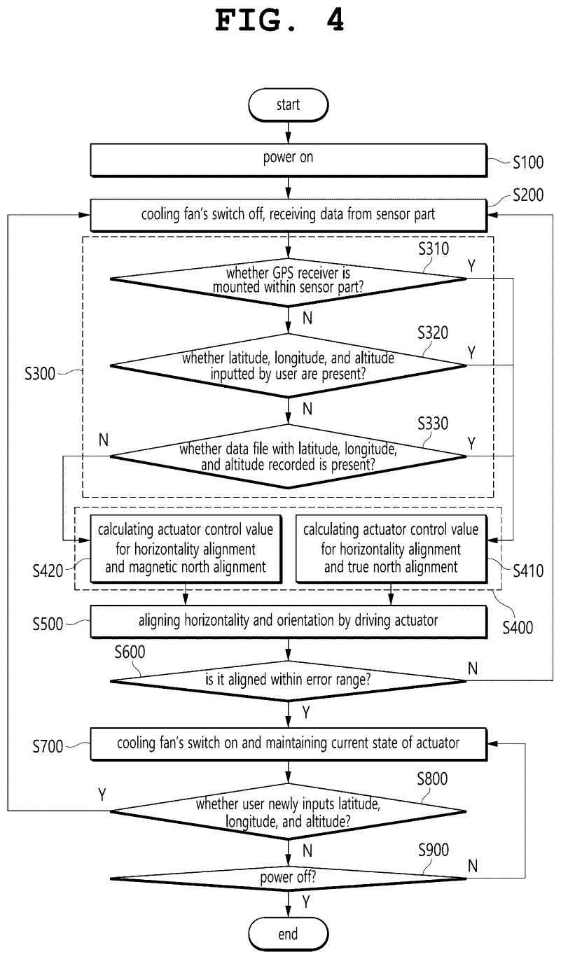

Hereinafter, a process of performing horizontality and orientation alignment of the portable cooling platform for taking off and landing of an unmanned autonomous aerial vehicle with the configurations described above will be described with reference to the attached FIG. 4.

The user may turn on the power of the portable cooling platform through the power supplier 700 (S100).

At the same time, the controller 500 may start operations for horizontality and orientation control of the take-off and landing pad 100.

First, the sensor part 400 may measure the magnetic field and gravitational acceleration in real time at the current location and then may transmit the same to the controller 500, and the controller 500 may perform the receiving data for receiving the orientation data and horizontality data of the take-off and landing pad 100 from the sensor part 400 (S200).

At this time, when the GPS is included in the sensor part 400, the latitude, longitude, and altitude values of the take-off and landing pad 100 measured through the GPS may be transmitted to the controller 500. At this time, the controller 500 may determine for itself whether the GPS is mounted in the sensor part 400, or a user may be known through setting.

Meanwhile, in the process of performing the receiving data, the controller 500 may turn off the operations of the cooling fan 200 so that distortion does not occur in the magnetic field when the sensor part 400 measures the orientation (heading) of the take-off and landing pad 100 through the magnetic field.

Next, the controller 500 may perform the determining the data among the data received from the sensor part 400, which determines whether the true north/magnetic north of the take-off and landing pad 100 is aligned (S300).

That is, the takeoff and landing pad 100 may be determined to be aligned with the true north or magnetic north depending on whether the sensor part 400 can obtain latitude, longitude, and altitude information.

That is, when the data provided by the sensor part 400 does not satisfy the condition for the true north alignment of the take-off and landing pad 100, the controller 400 may calculate data for the magnetic north alignment, and through this, the user may recognize in advance that the takeoff and landing pad 100 is aligned to the magnetic north, so that data on the true north alignment of the take-off and landing pad 100 may be identified through subsequent correction.

Meanwhile, in the determining data (S300), the conditions for determining whether the data received from the sensor part 400 is aligned with the true north/magnetic north may include whether a GPS is mounted on the sensor part 400 and data is measured through the GPS (S310), whether the user directly inputs latitude, longitude, and altitude values in a state where the user already knows the current location (S320), and whether the latitude, longitude, and altitude for the current location are data previously input to the database of the controller (S330).

Next, the controller 500 may perform calculating a control value for calculating an actuator 600 control value on the basis of the data provided from the sensor part 400 (S400).

At this time, the controller 500 may calculate an actuator 600 control value for aligning the horizontality of the take-off and landing pad 100 on the basis of the data where the sensor part 400 measures the gravitational acceleration of the take-off and landing pad 100.

In addition, when at least one of the conditions described above in the determining data (S300) is satisfied, the controller 500 may calculate an actuator 600 control value for the true north alignment (S410), or when all of the conditions described above are not satisfied, the controller 500 may calculate an actuator 600 control value for the magnetic north alignment.

Next, when the actuator 600 control value for the horizontality and orientation alignment of the take-off and landing pad 100 is calculated in the controller 500, the controller 500 may perform aligning for aligning the horizontality and orientation of the take-off and landing pad 100 by driving the actuator 600 in three axes (S500).

Meanwhile, the sensor part 400 may be inherently noisy in the process of measuring gravitational acceleration and magnetic field, and because of the noise generation, the controller 500 may finely readjust and align the take-off and landing pad 100 through the actuator 600.

At this time, the controller 500 may perform determining an error range for determining whether the noise of the sensor part 400 is within the error range (S600), and when it is within the error range, the controller 500 may stop the operations of the actuator 600 and may perform maintaining for maintaining the current state of the take-off and landing pad 100 (S700).

In this case, in the maintaining S700, the controller 500 may turn on the operations of the cooling fan 200. The maintaining S700 may be a step unrelated to the occurrence of magnetic field distortion during the measurement of the sensor part 400, so the controller 500 may operate the cooling fan 200.

Next, the controller 500 may perform identifying a re-input for identifying whether the user inputs the location data (latitude, longitude, altitude) of the take-off and landing pad 100 as a new value to the controller 500 (S800).

This step may be a case where the user incorrectly inputs the location data in the determining data S300 or newly inputs the orientation data because the GPS data according to the GPS shadow area is not accurate, and may be a step where the controller 500 finally identifies whether the already set location data is changed.

When it is determined that there is no new data input in the identifying the re-input S800, the controller 500 may maintain the current state until the power of the power supplier 700 is turned off (S700) while continuously identifying whether the power supplier 700 is turned off (S900).

With this, the horizontality and orientation alignment of the take-off and landing pad 100 may be completed.

Next, the user may bring a drone for performing a mission and may settle the drone on the landing surface 100a of the take-off and landing pad 100.

In this case, the user may insert and couple the drone's legs into each fixing part 120.

At this time, since the cooling fan 200 of the take-off and landing pad 100 is continuously operating, the cooling fan 200 may suppress the heat generation of each component at the lower part of the drone and can particularly prevent overheating of the LiDAR sensor.

Thereafter, the user may input data for performing the drone mission into the drone and may input to the drone the orientation data of the take-off and landing pad aligned with the true north or the magnetic north.

Thereafter, the drone may perform various missions on the basis of the orientation data of the take-off and landing pad 100 while autonomously flying, and may accurately return to the take-off and landing pad 100 on the basis of the orientation data of the take-off and landing pad input after completing the mission.

As described so far, the portable cooling platform for taking off and landing of an unmanned autonomous aerial vehicle and the alignment method thereof according to the present disclosure can cool a LiDAR sensor sensitive to overheating by operating a cooling fan until the drone takes off, and can reduce the takeoff and landing error of the drone by automatically aligning the orientation, thereby accurately performing the drone's mission.

What is claimed is:

1. A portable cooling platform for taking off and landing of an unmanned autonomous aerial vehicle, the platform comprising:
a take-off and landing pad comprising a landing surface where a drone lands;
a supporter for supporting the take-off and landing pad on the ground; and
a cooling fan provided on the take-off and landing pad for blowing wind in a landing direction of the drone.

2. The platform of claim 1, wherein the take-off and landing pad comprises a plurality of fixing parts, which prevent the drone's movement by fixing the drone's legs when the drone is landed on the landing surface.

3. The platform of claim 2, wherein the fixing part forms a groove into which the drone's legs are inserted and coupled.

4. The platform of claim 2, wherein the fixing part is formed in a circumference of the cooling fan, so that a lower center of the drone can correspond to the cooling fan when the drone's legs are fixed into the fixing parts.

5. The platform of claim 2, wherein the take-off and landing pad forms a cooling fan groove stepped from the landing surface so that the cooling fan can be installed, and
a blowing net for protecting the cooling fan is provided in the cooling fan groove.

6. The platform of claim 1, further comprising:
a sensor part for measuring a horizontality and orientation of the take-off and landing pad;
an actuator provided between the supporter and the take-off and landing pad for driving a movement of the take-off and landing pad; and
a controller for controlling the actuator on the basis of a horizontality value and orientation value of the take-off and landing pad measured through the sensor part.

7. The platform of claim 6, wherein the actuator comprises:
a first motor for adjusting an azimuth of the take-off and landing pad while generating power to horizontally rotate (yaw) with respect to the ground;
a second motor for adjusting a slope of a first area while generating power to vertically rotate (pitch) with respect to a rotation axis of the first motor; and
a third motor for adjusting a slope toward a second area perpendicular to the first area while generating power to vertically rotate (roll) with respect to a rotation axis of the second motor.

8. The platform of claim 6, wherein an operation of the cooling fan is controlled to be turned off when the sensor part measures the orientation.

9. The platform of claim 1, further comprising:
a power supplier for supplying power to the portable cooling platform for taking off and landing of the unmanned autonomous aerial vehicle.

10. The platform of claim 9, wherein the power supplier is configured to incorporate a battery thereof or to be supplied with power from an external power source.

11. The platform of claim 1, further comprising:
an interface where location information of the take-off and landing pad is input.

12. The platform of claim 1, wherein the supporter is configured as a foldable tripod.

13. A portable cooling platform for taking off and landing of an unmanned autonomous aerial vehicle, the platform comprising:
a take-off and landing pad composed of a landing surface where a drone lands;
a cooling fan provided on the take-off and landing pad for blowing wind in a landing direction of the drone;
a power supplier provided on a lower side of the take-off and landing pad for supplying power;
an actuator provided between the power supplier and the take-off and landing pad for driving a movement of the take-off and landing pad;
a supporter provided on the power supplier and supported on the ground,
wherein the supporter can be unfolded to be supported on the ground and be folded to be transportable.

14. The platform of claim 13, further comprising:
a sensor part provided on one surface of the take-off and landing pad for measuring a horizontality and orientation of the take-off and landing pad; and
a controller provided on one side of the sensor part for controlling the actuator on the basis of a horizontality value and orientation value of the take-off and landing pad measured through the sensor part.

15. An alignment method of a portable cooling platform for taking off and landing of an unmanned autonomous aerial vehicle, the method comprising:
receiving, horizontality data and orientation data of a take-off and landing pad measured from a sensor part by a controller;
determining whether true north/magnetic north is aligned through the data received by the controller;
calculating, by the controller, an actuator control value for the true north alignment of the take-off and landing pad when location information of the take-off and landing pad is known calculates or calculating, by the controller, an actuator control value for the magnetic north alignment of the take-off and landing pad when the location information of the take-off and landing pad is not known; and
aligning, by the controller, the horizontality and orientation of the take-off and landing pad by driving the actuator.

16. The method of claim 15, wherein the controller turns off an operation of a cooling fan when the sensor part measures the orientation of the take-off and landing pad.

17. The method of claim 15, further comprising:
after the aligning,
determining an error range, where whether noise of the data measured by the sensor part is out of an allowable range is determined; and
maintaining, the current state of the actuator by the controller when the noise of the sensor part is within the allowable range in the determining error range.

18. The method of claim 17, wherein the maintaining turns on the operation of the cooling fan by the controller.

19. The method of claim 17, wherein identifying, whether a user inputs the orientation data of the take-off and landing pad as a new value into the controller is further performed after the maintaining,
wherein in the identifying,
the maintaining, by the controller, is maintained until power is turned off when it is identified that the new value is not input, and
the receiving, is returned by the controller, and performed again when it is identified that the new value is input.

20. The method of claim 15, wherein the determining, by the controller, performs at least one of whether the sensor part is composed of a GPS, whether the orientation data input by a user is present, and whether a file where the orientation data is recorded is present.
